(19) United States
(12) Patent Application Publication
(10) Pub. No.: US 2019/0313719 A1
(43) Pub. Date: Oct. 17, 2019

(54) INSULATION FABRIC, INSULATION PRODUCT USING THE SAME, AND METHOD AND APPARATUS FOR MANUFACTURING INSULATION FABRIC

(71) Applicants: Youn Su JO, Seoul (KR); Young Su CHO, Geoje-si (KR)

(72) Inventors: Youn Su JO, Seoul (KR); Young Su CHO, Geoje-si (KR)

(21) Appl. No.: 16/343,166

(22) PCT Filed: Oct. 23, 2017
(86) PCT No.: PCT/KR2017/011721

§ 371 Date: Apr. 18, 2019

(30) Foreign Application Priority Data
Oct. 24, 2016 (KR) 10-2016-0138095

(51) Int. Cl. A41D 31/06; D03D 1/00; D06B 3/10; D06M 17/00

(52) U.S. Cl. CPC A41D 31/065; D03D 1/0035; D06B 3/10; B32B 27/12; D10B 2501/04; B32B 2307/304; B32B 2437/00; D06M 17/00

(57) ABSTRACT

Provided are an insulation fabric, an insulation product, and a manufacturing method and a manufacturing device therefor. The insulation fabric includes unit cells made by cutting an insulation layer or laminated unit cells made by cutting the insulation layer and laminating the cut insulation layer with lamination sheets to prevent fine particles from passing therethrough, the unit cells or the laminated unit cells being spaced from each other; and outer cover clothes or sheets covered on tops and undersides of the unit cells or the laminated unit cells. Sections on which the outer cover clothes or sheets are laminated, without any insulation layer, are formed between the unit cells or the laminated unit cells. On the sections, the outer cover clothes or sheets come into close contact with each other to divide unit cell spaces for covering the unit cells or the laminated unit cells.

### TECHNICAL FIELD

The present invention relates to an insulation material and, more particularly, to an insulation fabric that is capable of being processed to have various shapes adequate for an object to be insulated, an insulation product made of the insulation fabric, and a method and apparatus for manufacturing the insulation fabric.

### BACKGROUND ART

Many kinds of insulation materials, their structure, and methods for manufacturing them have been studied and developed.

Among the insulation materials, a high efficiency insulation material, which is capable of enhancing workability and being applicable for various purposes by means of reduction in weight and volume, is called a super insulation material, and recently, many studies on such super insulation material have been made. The super insulation material is processed with another material to make a convergence material, and accordingly, a product to which an appropriate function is applied can be made of the convergence material. Advantageously, the super insulation convergence material can handle serious temperature conditions and environments by means of super-insulating characteristics and properties of the material

For example, the convergence material resistant to a high temperature can be used diversely as curtains in a social public field like fire extinguishing, a flame resistance and insulation field of defense industry, eco-friendly environment insulation and radiation fields, and construction and agricultural facility fields, and as insulation materials in steel making, refining, shipbuilding, automobile, and offshore plant fields.

The super insulation material, which has excellent insulation effects, while being relatively low in thickness, has been recently used to make functional clothing like outdoor clothing, and as a result, many interests are paid on aerogels as the super insulation material.

In case where an outdoor composite material for keeping warm is used as a clothing material for a human body, by the way, the composite material has an excellent insulation effect, but it fails to discharge moisture from the human body, so that sweat remains in the clothing. Further, the composite material is not soft, but rigid, and accordingly, it is not proper that it is used as a cloth for making the clothing. Due to such problems, it is hard to apply the super insulation composite material for more various purposes, and actually, the super insulation composite material is used in an extremely limited field.

If the super insulation material is attached to the entire surface of the cloth so as to be used as an industrial material, the cloth to which the super insulation material is attached becomes substantially rigid, not soft, thereby providing low workability. Further, the cloth is not bent well to surround an object to be kept warm according to its purpose, is not expandable or contracted to provide no flexibility in shape, and causes the insulation material to become entangled therein, so that it can be limited in use as the industrial material.

### DISCLOSURE

### Technical Problem

Accordingly, the present invention has been made in view of the above-mentioned problems and limitations occurring in the insulation material like the existing super insulation composite material, and it is an object of the present invention to provide an insulation fabric, an insulation product using the insulation fabric, and a method and apparatus for manufacturing the insulation fabric that are configured to enhance workability in a state of a fabric, in spite of rigidity of an insulation material itself, so that the insulation fabric can have adequate structures in making various kinds of products and the insulation product can have a flexible shape appropriate for an object to improve marketability.

It is another object of the present invention to provide an insulation fabric, an insulation product using the insulation fabric, and a method and apparatus for manufacturing the insulation fabric that are configured to provide good workability and insulation efficiency and to ensure high air permeability and easy moisture discharging structure when especially processed to clothing.

It is yet another object of the present invention to provide an insulation fabric, an insulation product using the insulation fabric, and a method and apparatus for manufacturing the insulation fabric that are configured to allow a polymer type insulation layer or a blanket type insulation layer (made by impregnating a fabric with an insulation material like aerogels) to be multi-divided to the form of irregular patterns or regular cells, to fill the insulation material or blanket in the fabric to a desired pattern, and to allow the insulation layer to be not provided along the edge peripheries of the filled portions to achieve more rigid melting or attaching.

It is still another object of the present invention to provide an insulation fabric that is configured to allow an edge portion of an insulation material filled therein to make an air layer when coming into contact with an object to be heat radiated or kept in temperature, thereby improving the effects for keeping warm or cold.

It is yet another object of the present invention to provide an insulation fabric, an insulation product using the insulation fabric, and a method and apparatus for manufacturing the insulation fabric that are configured to prevent a super insulation material filled therein from being entangled or inclined by means of repeated pressures if the insulation fabric is used as a shoe insole or mat and to allow the portions (edges) around unit cells to be provided with no super insulation layer (super insulation material) even if the insulation fabric is used as a tent, cultivation curtain, and heat shielding curtain which are frequently moved and repeatedly operated, so that outer cover materials for covering both sides of the unit cells are rigidly melted and attached to each other to firmly fix a polymer or blanket type super insulation layer.

### Technical Solution

To accomplish the above-mentioned objects, according to a first aspect of the present invention, there is provided an insulation fabric including: a plurality of unit cells made by cutting an insulation layer or a plurality of laminated unit cells made by cutting the insulation layer and laminating the cut insulation layer with lamination sheets to prevent fine particles from passing therethrough, the unit cells or the laminated unit cells being spaced from each other; and outer cover clothes or sheets covered on tops and undersides of the unit cells or the laminated unit cells, wherein sections on which the outer cover clothes or sheets are laminated, without any insulation layer, are formed between the unit cells or the laminated unit cells, and on the sections, the outer cover clothes or sheets come into close contact with each other to divide unit cell spaces for covering the unit cells or the laminated unit cells, so that movements of the unit cells or the laminated unit cells are restricted between the unit cell spaces.

According to the present invention, desirably, the plurality of unit cells is repeatedly arranged with a given pattern according to the characteristics of the general fabric repeatedly mass-produced, and so as to enhance a degree of freedom and conveniences in workability at the time when the insulation fabric is used to make a product, each unit cell has a shape of a circle or any one of a triangle to octagon, a maximum size of a width or length of the unit cell being less than 5 cm.

According to the present invention, desirably, an area where the insulation layer exists is within 50 to 99% of the entire area thereof. If the rate of the insulation layer area is small, an insulation effect becomes reduced, and contrarily, if the rate thereof is large, spare spaces required for cutting, sewing, and other processes become reduced at the time when the fabric is processed to make the product.

According to the present invention, desirably, the insulation layer is made by impregnating a fabric with phase change aerogels to have the number of one or more layers required (blanket type) or molded by mixing or coating aerogel beads or powder with a binder (polymer type).

According to the present invention, desirably, the plurality of laminated unit cells is made by feeding the lamination sheets to tops and undersides thereof so as to allow the plurality of unit cells made by cutting the insulation layer to be kept spaced apart from each other and by melting or bonding areas (having no insulation layer) where the unit cells are spaced apart from each other, and otherwise, the lamination sheets are cut and divided by unit cells to allow the arrangement of the unit cells to be kept.

According to the present invention, desirably, on the sections where the outer cover clothes or sheets are laminated between the unit cells or the laminated unit cells, air ventilating or moisture discharging pores (fine holes) are formed on the outer cover clothes or sheets to allow both sides of the insulation fabric to communicate with each other.

According to the present invention, desirably, the outer cover clothes or sheets and the lamination sheets are softer and more expandable than the insulation layer when bent.

According to the present invention, desirably, the lamination sheets and the outer cover cloths or sheets are provided or only the outer cover cloths or sheets are provided on the areas between the unit cells, that is, having no insulation layer, and on the areas where only the lamination sheets are laminated with each other, the lamination sheets are kept melted or attached, the lamination sheets being formed of synthetic resin sheets like polyethylene sheets, polypropylene sheets, and so on, without being limited thereto. In some cases, the outer cover cloths or sheets are made of the same material as the lamination sheets, so that they can become an exterior of the product made of the insulation fabric according to the present invention.

To accomplish the above-mentioned objects, according to a second aspect of the present invention, there is provided an insulation product that is made of the insulation fabric according to the present invention.

To accomplish the above-mentioned objects, according to a third aspect of the present invention, there is provided a method for manufacturing an insulation fabric, including the steps of: arranging a plurality of insulation layer (insulation material) unit cells; and laminating the plurality of insulation layer unit cells arranged with lamination sheets to keep the arrangement of the plurality of insulation layer unit cells so that fine particles do not escape from the plurality of insulation layer unit cells.

According to the present invention, desirably, the method for manufacturing an insulation fabric further includes the step of feeding outer cover clothes or sheets made of a given functional material to the arrangement of the plurality of insulation layer unit cells laminated to cover the plurality of insulation layer unit cells and allowing at least a portion of areas between the unit cells to come into close contact with each other to prevent the unit cells from passing through the areas so that unit cell spaces in which the unit cells are located are divided.

According to the present invention, desirably, the step of arranging the plurality of insulation layer unit cells includes the step of making an insulation layer made by impregnating a fabric with an insulation material like aerogels to have the number of one or more layers or molded by mixing or coating aerogel beads or powder with a binder, placing and moving the insulation layer fabric on a base frame, and continuously cutting the insulation layer fabric by means of a roller type press cutter to allow the plurality of unit cells cut to a given shape and size to be arranged or at a time cutting the insulation layer fabric placed on a large base frame by means of a flat plate type press cutter (otherwise, placing a cutter frame on the insulation layer fabric and pressing the cutter frame against a press frame) to allow the plurality of unit cells to be arranged.

According to the present invention, desirably, the unit cells cut in the unit cell arranging step are kept in the same arrangement as those in the laminating step and the covering step through the outer cover sheets or clothes, and in this case, the processes from the arranging step to the covering step are automated and easily carried out continuously and collectively.

According to the present invention, desirably, so as to allow the plurality of insulation layer unit cells cut or the plurality of insulation layer unit cells laminated to be kept in arrangement, an adhesive sheet is fed to the tops or undersides of the plurality of unit cells arranged, and the plurality of insulation layer unit cells are moved in a state of being attached to the adhesive sheet. At this time, the adhesive sheet itself can become the lamination sheet (film).

To accomplish the above-mentioned objects, according to a fourth aspect of the present invention, there is provided an apparatus for manufacturing an insulation fabric, including: a cutting part, a laminating part, a covering part, and transferring parts disposed between the cutting part and the laminating part and between the laminating part and the covering part to maintain the arrangement of the unit cells and to move the unit cells between the cutting part and the laminating part and between the laminating part and the covering part. To do this, each transferring part is configured to remove a remnant except the unit cells and to maintain the arrangement of the unit cells.

According to the present invention, desirably, the insulation fabric can be made in such a manner as to allow a primary insulation layer to pass through the cutting part and the laminating part and then to allow the primary insulation layer to be cut to unit cells and then covered through another cutting part and the covering part continuously disposed. Even in this case, transferring parts are disposed between the parts to perform continuous work.

According to the present invention, desirably, the cutting part includes an upper press frame for performing pressurization, an intermediate cutting frame having cutters for piercing or cutting, and a lower base frame located under the insulation layer, and the upper press frame and the intermediate cutting frame can be formed integrally with each other. A roller type cutting part and a flat plate type cutting part are possible. Only one of the upper and lower parts is the roller type part, and the other is the flat plate type part, and otherwise, it is possible that all of the upper and lower parts are the flat plate type parts or the roller type parts.

According to the present invention, desirably, the insulation layer fabric is placed above the lower base frame and under the cutters, the cutters being open in areas on which the plurality of insulation layer unit cells is arranged, and an adhesive sheet is fed between the upper press frame and the cutters in such a manner as to be attached to the tops of the plurality of insulation layer unit cells cut by the cutters, so that the arrangement of the plurality of insulation layer unit cells can be kept in a convenient manner in a state where the tops of the plurality of insulation layer unit cells cut are fixedly attached to the adhesive sheet after passing through the cutting part. At this time, a transferring part is disposed before the laminating part after the cutting part to remove a remnant except the unit cells from the insulation layer fabric.

### Advantageous Effects

According to the present invention, the insulation fabric and the method and apparatus for manufacturing the insulation fabric are configured to enhance workability in a state of a fabric having an insulation layer, in spite of rigidity of the insulation material itself, so that the insulation fabric can have adequate structures in making various kinds of products and the insulation product can have a flexible shape appropriate for an object to improve marketability.

According to the present invention, in addition, the insulation fabric and the method and apparatus for manufacturing the insulation fabric are configured to provide good workability and insulation efficiency and to ensure high air permeability and an easy moisture discharging structure when especially processed to clothing.

In case of the conventional insulation blanket (blanket type super insulation layer) lamination technology, in detail, insulation blankets are laminated with each other, but in this case, it is hard to freely mold the laminated insulation blankets according to the shape of the human body. According to the present invention, however, the insulation blanket is disposed to the form of the arrangement of the plurality of fine and small unit cells between the fabrics or sheets, and at this time, it is possible to apply air permeability and moisture permeability to the fabrics between the unit cells. Further, the melting or attaching portions formed to divide the unit cells serve to rigidly fix the respective unit cells.

If a functional fabric capable of handling a severe environment is coupled to the insulation material, the inherent functions the covering fabric has are still provided on the portions between the insulation layer unit cells, so that the portions are soft and flexible, thereby discharging the moisture from the human body and providing air permeability, and the insulation layer unit cells are stably kept and distributed, thereby making it easy to manufacture a product capable of maintaining high durability and insulation performance.

As a result, the insulation fabric according to the present invention can be diversely and effectively applied to a human body application field and industrial and military fields where shaping performance and moldability are required. Further, the insulation fabric according to the present invention can be easily processed with various shaping performance and resistant to a high temperature according to the characteristics of the insulation material, so that the insulation fabric can be applied as an easily processible material to flame resistant materials in fire extinguishing, steel making, refining, and dispense fields, insulation, radiation, construction and agricultural facility curtains in stealth insulation and eco-friendly environment fields, and insulation materials in shipbuilding, automobile, and offshore plant fields.

### BRIEF DESCRIPTION OF DRAWINGS

FIG. 1 is a plan view showing an insulation fabric according to the present invention.

FIG. 2 is a front sectional view taken along the line A-A′ of FIG. 1.

FIG. 3 is a schematic block diagram showing an apparatus for manufacturing the insulation fabric according to the present invention before sewing lines are formed and the movements and states of components for making the insulation fabric.

FIGS. 4 and 5 are bottom and perspective views showing a flat plate type upper mold and a roll type upper mold of a cutting part in the apparatus according to the present invention.

FIGS. 6 and 7 are sectional views showing a cutter blade-integral type upper mold of the cutting part in the apparatus according to the present invention.

FIG. 8 is a block diagram showing a cutting part and a transferring part different from those in FIG. 3.

FIG. 9 is plan views showing variations in plane shapes of an insulation layer, lamination sheets, outer cover sheets or fabrics formed on the steps in the apparatus of FIG. 8.

### MODE FOR INVENTION

Hereinafter, the present invention will now be described in detail with reference to the attached drawings.

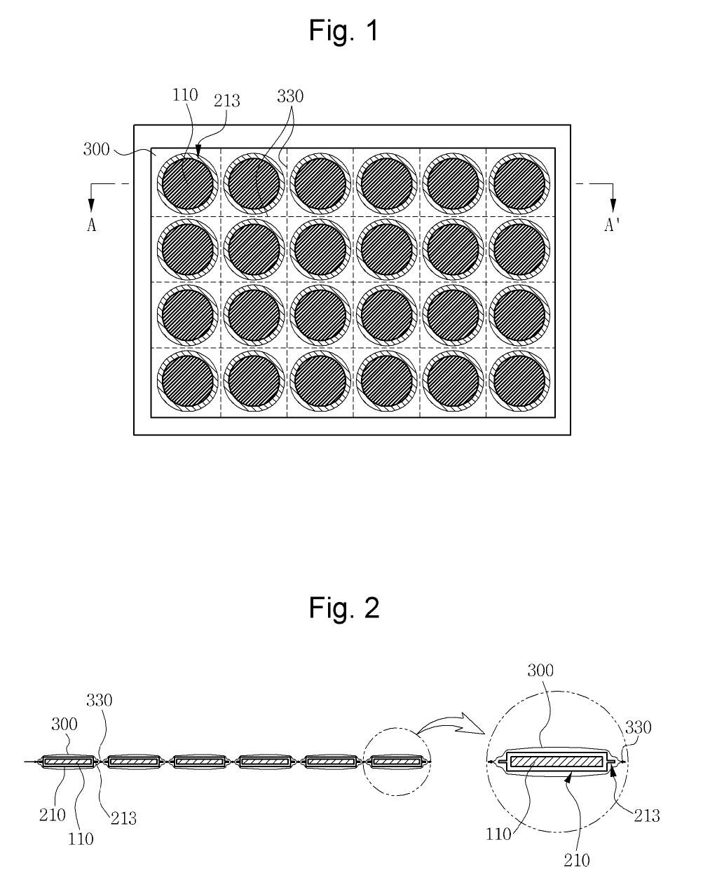

FIG. 1 is a plan view showing an insulation fabric according to the present invention, and FIG. 2 is a front sectional view of the insulation fabric according to the present invention.

In this case, the insulation fabric is elongated with a given width and has a plurality of circular unit cells (laminated unit cells 210) arranged in longitudinal and transverse directions therein. The circular unit cells are formed in such a manner as to allow tops and undersides of insulation layer unit cells 110 to be covered with lamination sheets, and the peripheral portions of the lamination sheets covered on the circular unit cells 210 are attached or melted to each other to form sealed portions 213, thereby preventing aerogel powder for constituting the insulation layer unit cells 210 from escaping therefrom. Further, sewing lines 330 are formed on the outer covering cloths or sheets 300 for covering the tops and undersides of the circular unit cells 210 to prevent the circular unit cells 210 from freely moving in the insulation fabric and to allow the circular unit cells 210 to be kept with a given arrangement and a given distribution density.

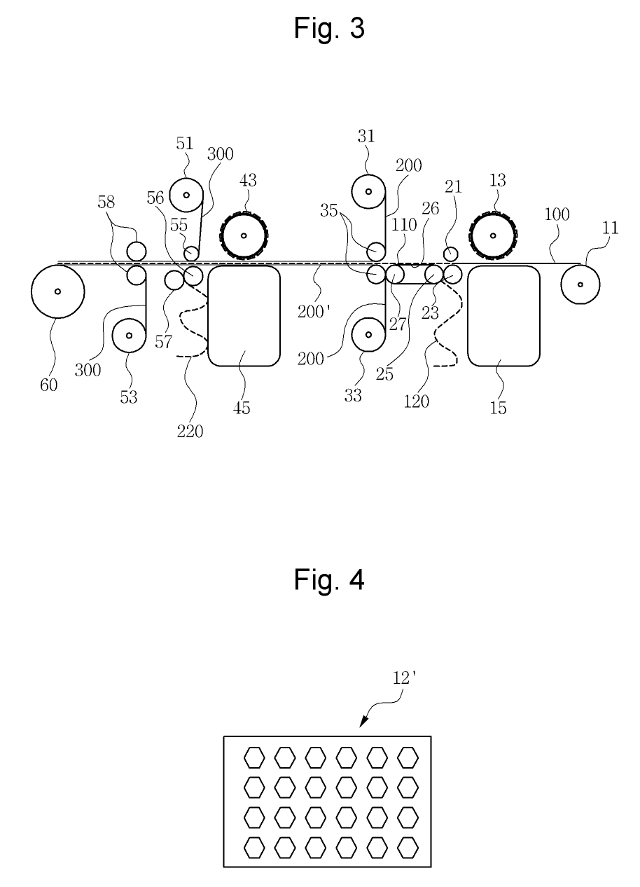

FIG. 3 is a block diagram showing an apparatus for manufacturing the insulation fabric according to the present invention before the sewing lines are formed and the movements and states of components for making the insulation fabric.

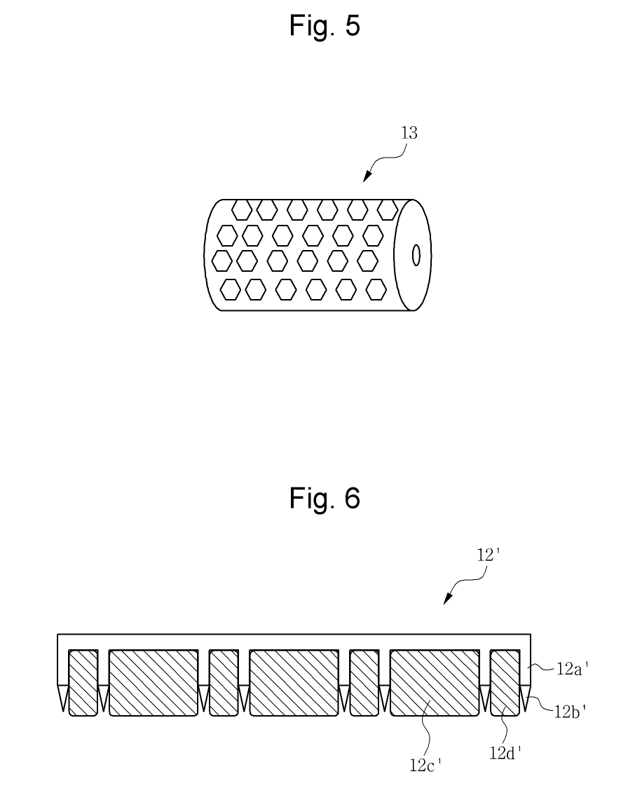

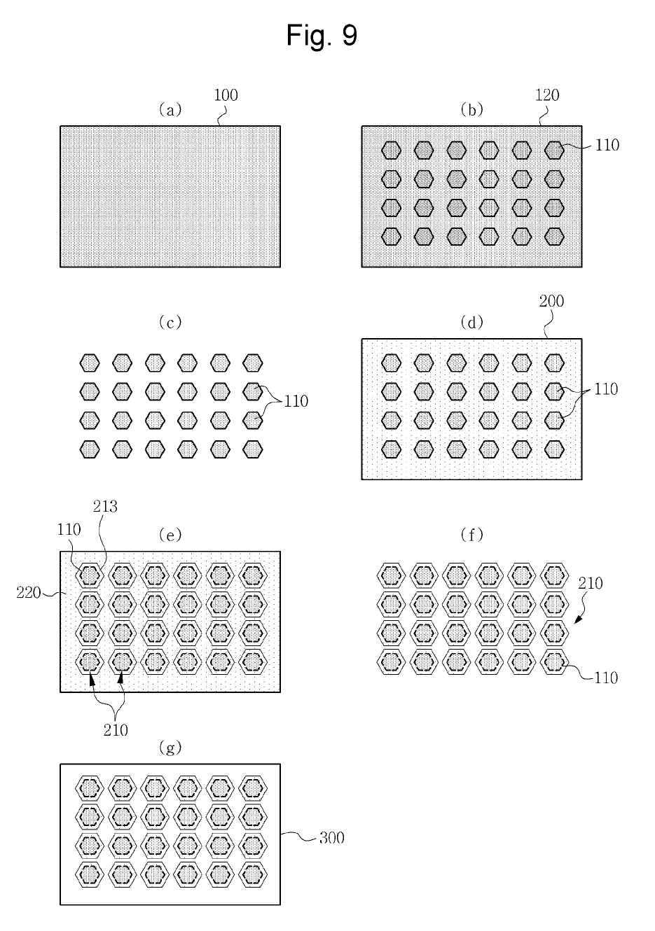

First, the apparatus for manufacturing the insulation fabric according to the present invention is configured to place a cutting part on a preceding portion thereof. The cutting part has a super insulation layer blanket fabric roll 11 disposed on an insulation layer fabric mounting stand, and to place a press cutter on the next position in a stream of process to cut an insulation layer fabric 100 and thus to form an arrangement of the plurality of unit cells 110. An upper portion of the press cutter is formed of a roller type mold 13 on which cutter blades are formed as shown in FIG. 5, and a lower portion of the press cutter is formed of a flat base frame 15 along which the insulation layer fabric 100 (See FIG. 9a) placed thereon is sliding.

In the cutting part, the roll type insulation layer fabric 100 is unrolled and moved to the next step in a state of being flat on the base frame 15, and in this process, the roller type mold 13 is rotated to allow the cutter blades continuously disposed to have the same shapes as of the unit cells on the surface thereof to be pressed against the insulation layer fabric as shown in FIG. 9a, so that the insulation layer fabric becomes in a state as shown in FIG. 9b. In this case, the plurality of unit cells 110 formed of the insulation layer and a remnant 120 disposed on the outside of the unit cells 110 exist together, while being divided by cutting lines, and the plurality of unit cells 110 are arranged with a repeated pattern.

Instead of the roller type mold 13, according to the present invention, a flat plate type mold 12′ on which the cutter blades having the repeated pattern are formed on the underside thereof can be provided as shown in FIG. 4. In this case, the insulation layer fabric 100 is not continuously moved, but it is moved by a given length and is thus placed on the base frame 15. Next, the mold 12′ is descended to cut the insulation layer fabric 100, and after that, the insulation layer fabric 100 is moved again by the given length. Further, the mold 12′ is descended to cut the insulation layer fabric 100. Like this, the steps are repeatedly carried out to cut the insulation layer fabric 100.

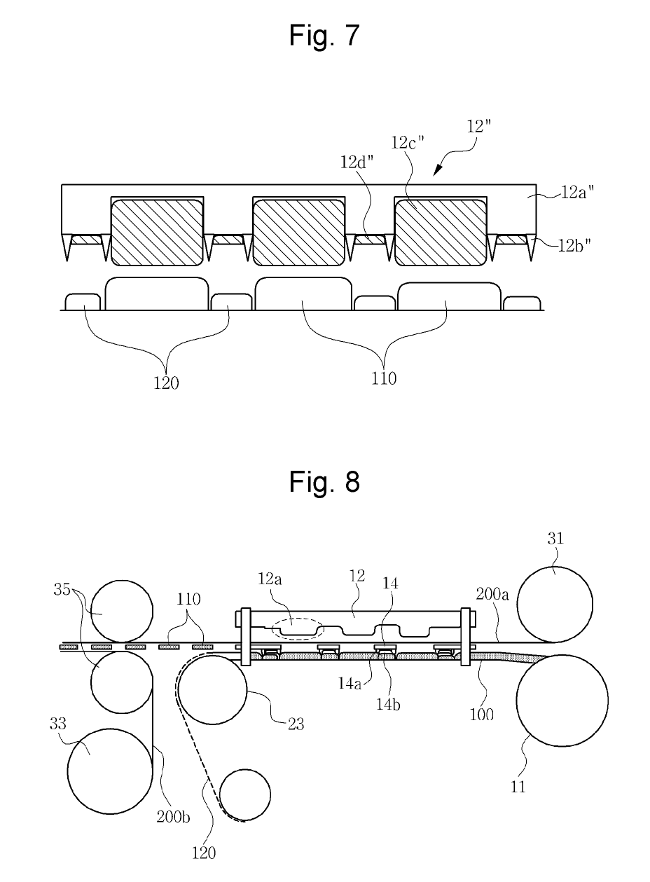

FIGS. 6 and 7 are sectional views showing the molds of the cutting part in the apparatus according to the present invention.

As shown in FIG. 6, the flat plate type mold 12′ includes a body 12a′ whose top is formed of a flat plate and cutter blades 12b′ arranged with a given pattern on the underside thereof. The body 12a′ is removed between the neighboring cutter blades 12b′ to form concave spaces. Small spaces between the cutter blades 12b′ correspond to the remnant 120 of the insulation layer fabric 100, and large spaces between the cutter blades 12b′ correspond to the unit cells 110 of the insulation layer fabric 100. Expandable members 12c′ and 12d′ like urethane foams, rubber foams, silicone foams, and so on are located at the spaces between the cutter blades 12b′, and they are contracted in such a manner as to be reduced in thickness when the mold 12′ is descended to allow the cutter blades to press and cut the insulation layer fabric 100, so that the cut insulation layer fabric can be accommodated in the spaces. If the mold 12′ is ascended after the cutting, the pressures of the expandable members 12c′ and 12d′ become lowered and returned to their original state, so that the cut insulation layer fabric accommodated in the spaces is just placed on the base frame 15, while being not raised along the mold 12′.

As shown in FIG. 7, a flat plate type mold 12″ includes cutter blades 12b″ having the same positions and sizes as shown in FIG. 6. However, concave spaces corresponding to the unit cells 110 are formed on the underside of a body 12a″, and concave spaces corresponding to the remnant 120 are not formed thereon. Further, relatively thick expandable members 12c″ are accommodated in the concave spaces, and relatively thin expandable members 12d″ are in spaces between the cutter blades 12b″.

In this case, as shown in FIG. 7, the unit cells 110 of the cut insulation layer fabric become in a state of a thick thickness similar to their original thickness, without being not compressed, and the remnant 120 is compressed upon cutting and becomes in a thin state. Of course, the pattern of the cutter blades 12b″ is not changed so that the shapes and arrangements of the unit cells 110 are the same when viewed on the plane.

The flat plate type upper mold of the press cutter has been explained with reference to FIGS. 6 and 7, but in case of the roller type upper mold, an explanation on the surface on which the cutter blades are formed is the same as in the above.

The insulation layer fabric after passing through the cutting part passes through a transferring part in a state of being divided into the unit cells 110 and the remnant 120. The transferring part includes a pair of transferring rollers 21 and 23 and a conveyor belt 26. The pair of transferring rollers 21 and 23 serves to hold the unit cells 110 and the remnant 120 on the opposite side to the insulation layer fabric roll 11 with respect to the press cutter and thus to move them forward. The remnant 120 passing through the pair of transferring rollers 21 and 23 is connected entirely when viewed on the plane, and the front end thereof is connected to a separate winding roller and is thus pulled downward, so that the remnant 120 is removed from the apparatus and thus recycled or thrown out. The unit cells 110 are arranged, while being separated from the remnant 120 (See FIG. 9c), and in this case, the sizes of the pair of transferring rollers 21 and 23 and the spaces between 21 and 23 and between the pair of transferring rollers 21 and 23 and the conveyor belt 26 are relatively smaller than the length (in an advancing direction) of each unit cell 110, so that the unit cells 110 can be transferred to the conveyor belt 26, while being kept in the arranged state. Rollers 25 and 27 serve to activate the conveyor belt 26.

A laminating part is disposed on the end of the conveyor belt 26. At the front side of the laminating part, a pair of transferring rollers 35 is disposed to receive and transfer the insulation layer unit cells 110 placed on the conveyor belt 26 in a forward direction, and while the insulation layer unit cells 110 are being fed to the pair of transferring rollers 35, lamination sheets 200 are also fed to the pair of transferring rollers 35 from lamination sheet rolls 31 and 33 located above and under the pair of transferring rollers 35. If the insulation layer unit cells 110 pass through the pair of transferring rollers 35, accordingly, they are laminated up and down with the lamination sheets 200 (See FIG. 9d).

At this time, the surface of the pair of transferring rollers 35 is made of an expandable material, and in this state where the insulation layer unit cells 110 and the lamination sheets 200 are laminated with each other, if they are pressurized against the expandable surface of the pair of transferring rollers 35, the upper and lower lamination sheets 200 can come into close contact with each other even in portions where only they are laminated with each other. If bonding or adhesive layers are formed on the facing inner surfaces of the lamination sheets 200, the lamination sheets 200 can be bonded or attached to each other by means of their close contact, and otherwise, if the lamination sheets 200 are heated, without any formation of the bonding or adhesive layers, the lamination sheets 200 (hot-melt sheets) are melted to form sealed portions. In detail, the portions where the bonding or melting is carried out serve to seal the spaces where there are the insulation layer unit cells 110 to prevent insulation material powder from leaking from the insulation layer unit cells 110.

A second cutting part is disposed on the next position (front) of the laminating part. Like the first cutting part, a press cutter is disposed on the second cutting part, and a configuration and an operation of the press cutter on the second cutting part are similar to those in the first cutting part.

Through the second cutting part, the portions where only the lamination sheets 200 are laminated with each other are cut by means of cutter blades to allow the laminated unit cells 210 to exist in a laminated remnant 220, which makes a state as shown in FIG. 9e. As a result, the laminated unit cells 210, which are covered with the lamination sheets (films) having larger areas than the insulation layer unit cells, are spaced apart from each other in such a manner as to have the same arrangement as of the insulation layer unit cells 110 in the pre-step thereof.

A covering part is disposed on the next position of the laminating part, while being merged with another transferring part. A transferring part of the covering part has partially similar shape and function to those of the transferring part located on the front of the cutting part. The transferring part of the covering part includes a pair of upper and lower transferring rollers 55 and 56 and an auxiliary roller 57 rotating in contact with the lower transferring roller 56 to remove the laminated remnant 220. The pair of upper and lower transferring rollers 55 and 56 transfers the laminated unit cells 210 and the laminated remnant 220 separated from each other through the second cutting part in a forward direction. The front end of the laminated remnant 220 is in advance set in such a manner as to be moved between the lower transferring roller 56 and the auxiliary roller 57 and thus removed from the arranged laminated unit cells 210. Accordingly, the arrangement of the laminated unit cells 210 remains as shown in FIG. 9f.

In the covering part, also, a roll 51, which is formed of an upper outer cover cloth 300 or sheet having an adhesive layer, is disposed above the upper transferring roller 55, so that the upper outer cover cloth 300 is fed between the upper transferring roller 55 and the lower transferring roller 56, while the laminated unit cells 210 are continuously fed therebetween. If the upper outer cover cloth 300 passes through the pair of transferring rollers 55 and 56, accordingly, it is moved forward in the state where the laminated unit cells 210 with the arrangement (as shown in FIG. 9f) are attached thereto.

Further, a pair of rollers 58 is disposed in front of the pair of transferring rollers 55 and 56, and a roll 53, which is formed of a lower outer cover cloth 300, is fed to the pair of rollers 58. The lower outer cover cloth 300 is laminatedly bonded to the upper outer cover cloth 300 having the arrangement of the laminated unit cells 210 before the pair of rollers 58 is operated, which makes a state as shown in FIG. 9g.

As a result, the laminated unit cells 210 are laminated with the upper and lower outer cover cloths 300. In this process, if bonding or adhesive layers are formed on the inner surfaces (facing the laminated unit cells 210) of the outer cover cloths 300, the upper and lower outer cover cloths 300 can be bonded or attached to each other by means of the pairs of rollers to form the bonded or attached portions with no insulation layer unit cells, and otherwise, if the upper and lower outer cover cloths 300 are heated, they are melted to form the bonded or attached portions with no insulation layer unit cells. The process can be similarly carried out to the bonding or melting of the upper and lower lamination sheets.

Accordingly, the insulation fabric having the arrangement of the laminated unit cells 210 between the upper and lower outer cover cloths 300 is manufactured. The insulation fabric is wound on a reel to provide an insulation fabric reel 60, and the insulation fabric is used to make an insulation product through post-processing.

Even if not mentioned herein, the sewing lines 330 as shown in FIG. 1 can be made to form sections of the laminated unit cells 210 on the insulation fabric before wound on the reel 60, so that the laminated unit cells 210 cannot escape from their position.

In the lamination step of the above-mentioned processes, in the state where pieces of the super insulation layer blanket fabric are arranged to a desired given size, if they are laminated with the lamination sheets and pressurized against the pair of rollers, air is removed from the super insulation layer blanket fabric, and in some cases, accordingly, vacuum portions where air is formed to a desired degree of vacuum are intentionally formed through a vacuum device. In this case, the degree of vacuum has a value between 760 to 0.2 torr. At this time, if gas barrier characteristics are applied to the lamination sheets (films), the blanket fabric is swollen by means of elasticity after the lamination, and accordingly, the sealed spaces covered with the lamination sheets are swollen to exert a vacuum insulation function, thereby improving insulation performance.

In case of the aerogel blanket, especially, if polymer felt holding aerogels is heated and compressed, the aerogel blanket has substantially lower thermal conductivity than general insulation materials through the proper function of the aerogels.

If it is desired to apply the outer cover cloths or sheets fed to the covering part to the human body, the outer cover cloths or sheets have a function of discharging sweat from the body or ventilating air therethrough, so that the insulation fabric can be used to make a product like functional clothing for protecting the body from serious cold or heat.

For example, the insulation fabric according to the present invention is cut and sewn, like a general clothing fabric, to make a jacket, so that it can be used to make the insulation jacket, and otherwise, the insulation fabric according to the present invention is made to the form of an insulation container such as an ice box or bag, so that it can be used to transfer or keep a product required to be warm or cool.

FIG. 8 is a block diagram showing a cutting part, a transferring part, and a laminating part whose configurations are partially different from those in FIG. 3.

In this case, a flat plate type mold is used as an upper press frame 12 of the press cutter of the cutting part, and in addition to the upper press frame 12, an intermediate cutting frame having cutters 14 for piercing or cutting is provided. Even if a lower base frame is not illustrated, it has the same flat shape as the upper press frame 12.

The insulation layer fabric 100 is cut in the state of being placed on the lower base frame and under the cutters 14, and at this time, the cutters 14 are open in the areas surrounded with cutter blades 14a, which become the fabric unit cells. Accordingly, the tops of the fabric unit cells are exposed above the cutters 14 in a state where the insulation layer fabric 100 is cut and separated by means of the cutter blades 14a. In the cutting process, next, an adhesive sheet 200a to be attached to the tops of the insulation layer unit cells is already fed between the cutters 14 and the upper press frame 12, and even though the upper press frame 12 is generally flat, the underside of the upper press frame 12 is formed in such a manner as to allow portions corresponding to the insulation layer unit cells to protrude downward therefrom. The edge portions of the upper press frame 12 and the cutters 14 are penetratedly fitted to guide rods disposed vertically so that the upper press frame 12 and the cutters 14 can be moved up and down along the guide rods.

In this state, if the press cutter is operated, the upper press frame 12 is pressed above the adhesive sheet 200a toward the cutters 14 to allow the cutters 14 to be compressed against the insulation layer fabric 100, and the insulation layer fabric 100 is cut dividedly into the unit cells and the remnant by means of the cutter blades 14a. Moreover, the downward protruding portions 12a of the upper press frame 12 are attached to the tops of the unit cells on which the adhesive sheet 200a is cut.

If the upper press frame 12 is lifted up after cutting, accordingly, the insulation layer unit cells having a given arrangement are attached to the adhesive sheet 200a to an original height of the adhesive sheet 200a and are thus located above the cutters 14. Only the remnant of the insulation layer fabric remains on the lower base frame, and the front end of the remnant is transferred by means of a roller 23 and then removed. The adhesive sheet 200a serves to easily separate the unit cells from the remnant and stably keep the arrangement of the unit cells, without any transferring conveyor belt, at the time of next process, and further, a lower lamination sheet roll 33 is disposed under the pair of transferring rollers 35 to feed a lower lamination sheet 200b to the pair of transferring rollers 35.

As a result, the insulation layer unit cells are coveredly laminated with the upper and lower lamination sheets through the pair of transferring rollers 35. After that, post-processes are similarly carried out like the processes as shown in FIG. 3, and a detailed explanation on them will be avoided for the brevity of the description.

Of course, if the adhesive sheet is not proper for the lamination sheet, it is removed at the pre-step of the pair of transferring rollers 35, and like FIG. 3, the upper and lower lamination sheets are fed to the pair of transferring rollers 35 to cover the insulation layer unit cells. Otherwise, the upper lamination sheet is separately fed to the pair of transferring rollers 35 in the state where the adhesive sheet is provided, so that the upper and lower lamination sheets are fed to cover the insulation layer unit cells.

In some cases, the lamination sheets may become the outer cover sheets or clothes, and at this time, the tops and undersides of the unit cells are covered with the lamination sheets. In this state, the bonding or melting is made on the areas where the lamination sheets are laminated, without any insulation layer unit cells, to allow the cell spaces for the insulation layer unit cells to be divided into each other, so that the insulation fabric according to the present invention can be manufactured.

The insulation fabric may have various shapes and materials known in the conventional practices, but according to the present invention, the insulation fabric includes a blanket made by impregnating a fabric with phase change aerogels to have the number of layers required, a polymer molded by mixing or coating super insulation powder or beads with a polymer binder, and a super insulation polymer made of a polymer material having a super insulation foaming pad having lightness and low density pores and adequate for an ultra high temperature, an ultra low temperature, and a medium temperature.

Various synthetic films can be used as the lamination films or sheets so as to prevent insulation powder from leaking to the outside, and in some cases, the lamination films or sheets themselves can be made of materials for forming the outer covers of the insulation fabric.

The mold for cutting and dividing the insulation material can be made three dimensionally through CNC. Further, the mold has a heater disposed therein to easily perform thermal cutting and is coupled to a pressurizing device. The roll type mold or flat type mold has the cutter blades and further has the expandable members filled in the concave spaces of the underside of the mold body. Otherwise, the mold may have the concave spaces with different depths according to areas, and further, the concave spaces are formed in low depths, so that when the mold is descended to cut the insulation layer fabric, the remnant is compressed by means of pressurization and heating on the concave spaces pressing the remnant to allow the heights of the unit cells to be intentionally different from the height of the remnant.

Even though not shown and explained in detail in the embodiment of the present invention, the operating structures of the rollers or press cutters and the continuous or intermittent operating pattern thereof are diversely provided like the existing manner, and if necessary, it is possible to further have mechanical components like conveyor belts or rollers.

The surface of the pair of transferring rollers is made of a high elastic material to press or heat the sheet or fabric passing therethrough from both sides thereof, which is well known in the existing manner, and therefore, a detailed explanation on the material of the surface of the pair of transferring rollers will be avoided for the brevity of the description.

According to the present invention, as the super insulation layer is laminated with the lamination sheets, the problem that the super insulation layer becomes loose or entangled so that it is changed in position or damaged, occurring in the post-processes, can be completely solved. Accordingly, if the insulation fabric according to the present invention is used as an industrial material like a curtain, tent, and a packing material to which repeated mechanical forces or manipulations are applied, many advantages can be obtained.

When the insulation fabric according to the present invention is made by attaching or melting the outer cover sheets or cloths to a fabric selected according to functions at the time when the outer cover sheets or cloths are coupled to both sides of the lamination unit cells, non-vapor permeable and non-air permeable melted portions of the lamination sheets are removed from the functional fabric through the post-process or use, so that the characteristics of the functional fabric can be well exerted.

The areas, on which there are no insulation layer unit cells, for dividing the insulation layer unit cells through the separation of the functional fabric from the melted portions of the lamination sheets, are soft because of the non-existence of rigid materials, thereby providing easy activities for users. The cell spaces are dividable by means of the outer cover sheets or cloths, the sewing lines, bonding, and melting, so that the insulation layer unit cells are stably fixed to provide good durability at the time when they are washed, have friction, or at the time when any load is applied thereto.

The functional fabric for the outer cover includes a life form fabric like a general polyester material, cotton, and so on, an industrial fabric like a Kevlar fabric strong at a high temperature, an aramid fabric, a polyimide high temperature film, an immersion fabric, and so on, all films on which an adhesive agent can be coated for melting, and fiber materials.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. An insulation fabric comprising:
a plurality of unit cells made by cutting an insulation layer or a plurality of laminated unit cells made by cutting the insulation layer and laminating the cut insulation layer with lamination sheets to prevent fine particles from passing therethrough, the unit cells or the laminated unit cells being spaced from each other; and
outer cover clothes or sheets covered on tops and undersides of the unit cells or the laminated unit cells,
wherein sections on which the outer cover clothes or sheets are laminated, without any insulation layer, are formed between the unit cells or the laminated unit cells, and on the sections, the outer cover clothes or sheets come into close contact with each other to divide unit cell spaces for covering the unit cells or the laminated unit cells, so that movements of the unit cells or the laminated unit cells are restricted between the unit cell spaces.

2. The insulation fabric according to claim 1, wherein each unit cell has a shape of a circle or a polygon under an octagon, and a width of the unit cell or a length of any one side thereof is less than 5 cm.

3. The insulation fabric according to claim 1, wherein an area where the insulation layer exists is within 50 to 99% of the entire area thereof.

4. The insulation fabric according to claim 1, wherein the insulation layer is made by impregnating a fabric (a woven fabric or non-woven fabric) with phase change aerogels to have the number of one or more layers (blanket type) or molded by mixing or coating aerogel beads or powder with a binder (polymer type).

5. The insulation fabric according to claim 1, wherein on the sections where the outer cover clothes or sheets are laminated between the unit cells or the laminated unit cells, air ventilating pores or moisture discharging pores are formed on the outer cover clothes or sheets to allow both sides of the insulation fabric to communicate with each other.

6. The insulation fabric according to claim 1, wherein the outer cover clothes or sheets and the lamination sheets are softer and more expandable than the insulation layer when bent.

7. A method for manufacturing an insulation fabric, comprising the steps of:
arranging a plurality of insulation layer unit cells;
laminating the plurality of insulation layer unit cells with lamination sheets to keep the arrangement of the plurality of insulation layer unit cells so that fine particles do not escape from the plurality of insulation layer unit cells; and
feeding outer cover clothes or sheets to the arrangement of the plurality of insulation layer unit cells laminated to cover the plurality of insulation layer unit cells, allowing at least a portion of areas between the unit cells to come into close contact with each other to prevent the unit cells from passing through the areas so that unit cell spaces in which the unit cells are located are divided.

8. The method according to claim 7, wherein the arrangement of the plurality of insulation layer unit cells laminated is the same as the arrangement of the insulation layer unit cells.

9. The method according to claim 7, wherein the step of arranging the plurality of insulation layer unit cells comprises the steps of making an insulation layer fabric with an insulation material and cutting the plurality of insulation layer unit cells, while the insulation layer fabric is being continuously or step by step transferred, in such a manner as to place the insulation layer fabric on a base frame and to press the insulation layer fabric by means of a cutting mold having an unit cell arrangement to arrange the plurality of insulation layer unit cells.

10. The method according to claim 7, wherein at least one step of the steps further comprises the step of feeding an adhesive sheet to tops or undersides of the plurality of insulation layer unit cells to allow the arrangement of the plurality of insulation layer unit cells to be maintained and moving the adhesive sheet attached to the plurality of insulation layer unit cells.

11. The method according to claim 9, further comprising the step of, after the cutting step and before the lamination step, removing a remnant except the plurality of insulation layer unit cells arranged from the insulation layer fabric.

12. The method according to claim 7, further comprising the step of, at the time when the unit cells are fixed by means of the outer cover clothes or sheets, fixing the edges of the unit cell spaces to a designed shape through computer sewing to allow the respective unit cell spaces to be fixed in position.

13. An apparatus for manufacturing an insulation fabric, comprising:
a cutting part having a base frame on which an insulation layer fabric is placed and cutter blades arranged with a given unit cell pattern to cut the insulation layer fabric placed on the base frame in such a manner as to form an arrangement of a plurality of insulation layer unit cells;
a laminating part for receiving the arrangement of the plurality of insulation layer unit cells from the cutting part to feed lamination sheets to the tops and undersides of the plurality of insulation layer unit cells arranged;
a covering part for feeding outer cover cloths or sheets to the tops and undersides of the plurality of insulation layer unit cells laminated; and
a removing part for removing a remnant except the plurality of insulation layer unit cells from the insulation layer fabric if the plurality of insulation layer unit cells arranged is transferred between the cutting part and the laminating part.

14. The apparatus according to claim 13, wherein the cutter blades of the cutting part are disposed on a surface of a roller, so that at the time when the insulation layer fabric is continuously moved on the base frame, the roller rotates and pressurizes the insulation layer fabric to allow the cutter blades to cut the insulation layer fabric, and the cut insulation layer fabric is pulled by means of a pair of rollers disposed on the next position of the cutting part, so that the remnant is pulled through separate means in a different direction from the advancing direction of the plurality of insulation layer unit cells through the pair of rollers and is separated from the plurality of insulation layer unit cells.

15. The apparatus according to claim 13, wherein the cutting part comprises the base frame, cutters located movable up and down above the insulation layer fabric, and an upper press frame located movable up and down above the cutters in such a manner as to pressurize the cutters when pressed, the cutters being open in areas on which the plurality of insulation layer unit cells is arranged and the underside of the upper press frame on the areas protruding downward toward the cutters, and an adhesive sheet is fed between the upper press frame and the cutters, so that if the upper press frame is pressurizedly moved down, the cutters are pressed to divide the insulation layer fabric into the plurality of insulation layer unit cells and the remnant, and the adhesive sheet is pulled by means of a pair of rollers disposed on the next position of the cutting part, while the remnant is being pulled and removed through the separate means from the base frame to allow the next section of the insulation layer fabric to be placed on the base frame.

16. The apparatus according to claim 13, wherein the laminating part comprises at least one pair of rollers adapted to move the plurality of insulation layer unit cells in such a manner as to allow the lamination sheets to be fed from lamination sheet rolls to the tops and undersides of the plurality of insulation layer unit cells moving along the pair of rollers.

17. The apparatus according to claim 13, wherein at the time when the upper and lower lamination sheets are attached to the plurality of insulation layer unit cells in the entire process of the laminating part, vacuum is applied from a vacuum device to allow the edge of the insulation material to be melted and laminated, and a degree of vacuum has a value between 760 to 0.2 torr.

18. An insulation product using the insulation fabric according to claim 1.
